(19) United States
(12) Patent Application Publication
(10) Pub. No.: US 2025/0055963 A1
(43) Pub. Date: Feb. 13, 2025

(54) RECORDING MEDIUM RECORDING PROGRAM, CONTENT EDITING METHOD, AND INFORMATION PROCESSING DEVICE

(71) Applicant: SEIKO EPSON CORPORATION, Tokyo (JP)

(72) Inventors: Kazuyoshi KITABAYASHI, AZUMINO-SHI (JP); Saki TAKEUCHI, AZUMINO-SHI (JP)

(21) Appl. No.: 18/797,652

(22) Filed: Aug. 8, 2024

(30) Foreign Application Priority Data
Aug. 8, 2023 (JP) 2023-129320

(51) Int. Cl. H04N 9/31; G06T 11/60

(52) U.S. Cl. CPC H04N 9/3179; G06T 11/60; G06T 2200/24

(57) ABSTRACT

There is provided a recording medium recording a program, the program causing a computer to execute executing first processing of acquiring, based on a plurality of captured images obtained by respectively capturing a plurality of pattern images sequentially projected from a projector onto a projection region, measurement information used for adjustment of a projection image projected onto the projection region and executing, in a period in which the first processing is executed, second processing that is processing different from the first processing and concerning the projection image.

The present application is based on, and claims priority from JP Application Serial Number 2023-129320, filed Aug. 8, 2023, the disclosure of which is hereby incorporated by reference herein in its entirety.

### BACKGROUND

### 1. Technical Field

The present disclosure relates to a recording medium recording a program, a content editing method, and an information processing device.

### 2. Related Art

In projection mapping for projecting an image onto a projection object, which is a stereoscopic object, using equipment such as a projector, in general, the position, the shape, and the size of the image are adjusted to match the position, the shape, and the size of the projection object.

For example, JP-A-2021-158625 describes that a captured image is generated by capturing at least a part of a projection image projected by a projector onto a projection object and at least one of the position and the size of the projection image in the captured image is set. In this setting, a measurement result is used based on a plurality of captured images obtained by capturing each of plurality of pattern images such as binary codes a sequentially projected from the projector onto a projection surface.

JP-A-2021-158625 is an example of the related art.

In JP-A-2021-158625, it is necessary to repeat the projection and the capturing of the pattern images a number of times corresponding to the display resolution of the projector. In the technique described in JP-A-2021-158625, other processing is executed after the measurement. Since the execution of the other processing cannot be received during the measurement, there is a problem in that it takes a long time from the start of the measurement to the completion of the setting of the projection image.

### SUMMARY

According to an aspect of the present disclosure, there is provided a recording medium recording a program, the program causing a computer to execute: executing first processing of acquiring, based on a plurality of captured images obtained by respectively capturing a plurality of pattern images sequentially projected from a projector onto a projection region, measurement information used for adjustment of a projection image projected onto the projection region; and executing, in a period in which the first processing is executed, second processing that is processing different from the first processing and concerning the projection image.

According to an aspect of the present disclosure, there is provided a content editing method including: executing first processing of acquiring, based on a plurality of captured images obtained by respectively capturing a plurality of pattern images sequentially projected from a projector onto a projection region, measurement information used for adjustment of a projection image projected onto the projection region; and executing, in a period in which the first processing is executed, second processing that is processing different from the first processing and concerning the projection image.

According to an aspect of the present disclosure, there is provided an information processing device including a processing device configured to execute: executing first processing of acquiring, based on a plurality of captured images obtained by respectively capturing a plurality of pattern images sequentially projected from a projector onto a projection region, measurement information used for adjustment of a projection image projected onto the projection region; and executing, in a period in which the first processing is executed, second processing that is processing different from the first processing and concerning the projection image.

### BRIEF DESCRIPTION OF THE DRAWINGS

FIG. 1 is a diagram illustrating an overview of a system used for a content editing method according to a first embodiment.

FIG. 2 is a block diagram of an information processing device according to the first embodiment.

FIG. 3 is a flowchart illustrating a flow of the content editing method according to the first embodiment.

FIG. 4 is a diagram illustrating installation of a projector.

FIG. 5 is a diagram illustrating an instruction to start execution of first processing.

FIG. 6 is a diagram illustrating selection of a content image.

FIG. 7 is a diagram illustrating a display example of a content image superimposed on an initially captured image.

FIG. 8 is a diagram illustrating a display example after the first processing.

FIG. 9 is a diagram illustrating a display example after the first processing.

FIG. 10 is a diagram illustrating editing of the content image after the first processing.

FIG. 11 is a diagram illustrating generation of a projection image.

FIG. 12 is a diagram illustrating a display example during generation of a projection image.

FIG. 13 is a diagram illustrating a display example of completion of the generation of the projection image.

FIG. 14 is a diagram illustrating projection using an edited content image.

FIG. 15 is a flowchart illustrating a flow of a content editing method according to a second embodiment.

FIG. 16 is a diagram illustrating a display example of a content image superimposed on a line drawing.

### DESCRIPTION OF EMBODIMENTS

Preferred embodiments according to the disclosure are explained below with reference to the accompanying drawings. Note that, in the drawings, the dimensions and the scales of units are different from actual ones as appropriate. Some portions are schematically illustrated in order to facilitate understanding. The scope of the present disclosure is not limited to these embodiments unless particularly described to limit the present disclosure in the following explanation.

### 1. First Embodiment

### 1-1. Overview of a System Used for a Content Editing Method

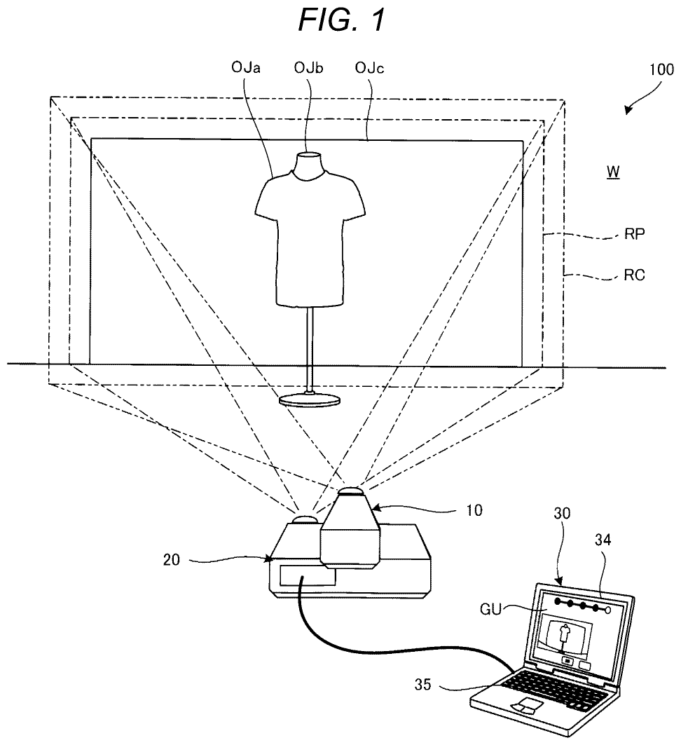

FIG. 1 is a diagram illustrating an overview of a system 100 used for a content editing method according to a first embodiment. The system 100 is a projection mapping system that projects an image to match the shape and the like of an object OJa that is a projection target object.

In the example illustrated in FIG. 1, the object OJa is a plain T shirt of white or the like in a state of being worn on an object OJb. The object OJb is, for example, a torso or a mannequin. The shape, the size, the position, and the like of each of the objects OJa and OJb are not limited to the example illustrated in FIG. 1 and are optional. The object OJa only has to be a projection target object of projection mapping and is not limited to the T-shirt and is optional. The object OJb is not limited to the torso or the mannequin and may be used according to necessity or may be omitted.

As illustrated in FIG. 1, the system 100 includes a camera 10, a projector 20, and an information processing device 30. The units of the system 100 are briefly explained below with reference to FIG. 1.

The camera 10 is a digital camera including a capturing element such as a CCD (Charge Coupled Device) or a CMOS (Complementary Metal Oxide Semiconductor). The camera 10 generates captured image data DGa explained below indicating a captured image obtained by capturing an image of the objects OJa and OJb. Here, the objects OJa and OJb are present in an image capturing region RC that is a region where image capturing by the camera 10 is possible.

In the example illustrated in FIG. 1, the image capturing region RC includes an object OJc besides the objects OJa and OJb. The object OJc is a screen installed along a wall surface W located behind the objects OJa and OJb when viewed from the camera 10 and the projector 20. The object OJc is used according to necessity or may be omitted. An installation position and an installation posture of the camera 10 are not limited to the example illustrated in FIG. 1 and are optional. Further, the camera 10 may be a part of the information processing device 30.

The projector 20 is a display device that projects an image onto the object OJa under the control by the information processing device 30. Here, the projection region RP, which is a region where projection by the projector 20 is possible, includes the objects OJa, OJb, and OJc.

In the example illustrated in FIG. 1, the projection region RP is included in the image capturing region RC. The projection region RP only has to include the objects OJa and OJb and may include a portion not included in the image capturing region RC. An installation position and an installation posture of the projector 20 are not limited to the example illustrated in FIG. 1 and are optional.

Although not illustrated, the projector 20 includes an image processing circuit, a light source, a light modulation device, and a projection optical system. The image processing circuit of the projector 20 is a circuit that controls driving of the light modulation device of the projector 20 based on information from the information processing device 30. The light source of the projector 20 includes, for example, halogen lamps, xenon lamps, ultra-high pressure mercury lamps, LEDS (Light

Emitting Diodes), or laser light sources, which respectively emit red light, green light, and blue light. The light modulation device of the projector 20 includes three light modulation elements provided to correspond to red, green, and blue. Each of the three light modulation elements is a display panel such as a transmissive liquid crystal panel, a reflective liquid crystal panel, or a DMD (digital mirror device). The three light modulation elements respectively modulate red, green, and blue lights based on a signal from the image processing circuit of the projector 20 to generate image lights of the colors. The image lights of the colors are combined by a color combination optical system to be full color image light. The projection optical system of the projector 20 is an optical system including a projection lens and projects the full color image light explained above onto a projection target object to form an image thereon.

The information processing device 30 is a computer that executes a content editing method explained in detail below. The information processing device 30 has a function of controlling operations of the camera 10 and the projector 20, a function of executing first processing S1 of measuring a projection surface of the projector 20 using the camera 10 and the projector 20, and a function of editing an image used for projection by the projector 20 using a result of the measurement and a captured image acquired from the camera 10.

In the example illustrated in FIG. 1, the information processing device 30 is a laptop computer. The information processing device 30 is not limited to the laptop computer and may be, for example, a desktop computer, a smartphone, or a tablet terminal. When the information processing device 30 has a capturing function, the information processing device 30 may also serve as the camera 10.

As explained in detail below, the information processing device 30 includes a display device 34 and an input device 35 and causes the display device 34 to display a user interface image GU, which is a GUI (graphical user interface) image necessary for executing the content editing method. In the drawings, “user interface” is sometimes described as “UI”. Then, the information processing device 30 executes, based on an instruction from a user via the input device 35, editing of an image used for projection by the projector 20. The user interface image GU is capable of receiving, from the user, editing operation for matching the shape of an image projected from the projector 20 onto a projection target object with the shape of the projection target object. Here, the user interface image GU is capable of receiving an instruction to execute first processing of measuring the projection surface of the projector 20 and is capable of receiving an instruction of second processing S2 different from the first processing S1 during the execution of the first processing.

### 1-2. Information Processing Device

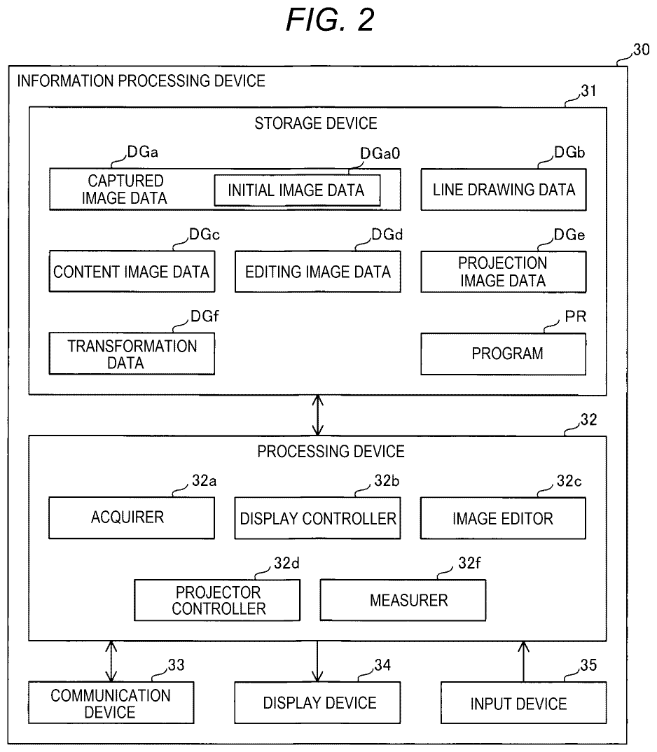

FIG. 2 is a block diagram of the information processing device 30 according to the first embodiment. As illustrated in FIG. 2, the information processing device 30 includes a storage device 31, a processing device 32, a communication device 33, a display device 34, and an input device 35. These devices are communicably connected to one another.

The storage device 31 is a storage device that stores programs such as an operating system and application programs to be executed by the processing device 32 and data to be processed by the processing device 32. The storage device 31 includes, for example, a hard disk drive or a semiconductor memory. A part or the entire storage device 31 may be an external storage device of the information processing device 30 or may be provided in an external device such as a server connected to the information processing device 30 via a communication network such as the Internet.

The storage device 31 stores a program PR, captured image data DGa, line drawing data DGb, content image data DGc, editing image data DGd, projection image data DGe, and transformation data DGf. The transformation data DGf is an example of “measurement information”.

The program PR is a program for executing a content editing method explained in detail below. The captured image data DGa is data indicating a captured image acquired from the camera 10. The captured image data DGa is data indicating a plurality of captured images obtained at the time of measurement in a measurer 32e explained below and includes initial image data DGa0 indicating a captured image obtained by capturing an image of the projection region RP in the initial state. The initial image data DGa0 is obtained by capturing an image of the projection region RP on which nothing is projected or by capturing an image of the projection region RP when a black image or a white image included in a plurality of pattern images explained below is projected onto the projection region RP. However, the captured image data DGa may include data indicating a captured image different from a captured image obtained at the time of measurement in the measurer 32e explained below. The line drawing data DGb is data in which the captured image indicated by the captured image data DGa is expressed by a line drawing. The content image data DGc is data indicating a content image Gc indicating content. The content image is an image illustrating a photograph, a pattern, a color, a combination thereof, or the like as content. The content image may be a moving image or a still image. The content image data DGc only has to include at least one piece of data indicating the content image Gc. In the present embodiment, the content image data DGC includes a plurality of data files indicating the content image Gc. A method of acquiring a data file indicating a content image is optional. For example, at least one of the data files may be stored in the information processing device 30 in advance or may be acquired from the outside of the information processing device 30. The editing image data DGd is data indicating an image in which the content image Gc indicated by the content image data DGc is superimposed on the line drawing indicated by the line drawing data DGb. However, for example, before the line drawing data DGb is generated, the editing image data DGd is data indicating an image in which the content image indicated by the content image data DGc is superimposed on the image indicated by the initial image data DGa0. The projection image data DGe is data indicating an image projected onto the object OJa by the projector 20. The transformation data DGf is data indicating a transformation matrix for performing projective transformation between a coordinate system of a captured image of the camera 10 and a coordinate system of the display panel of the projector 20. As the editing image data DGd, the captured image data DGa may be used instead of the line drawing data DGb. That is, the image indicated by the editing image data DGd may be an image in which the content image indicated by the content image data DGc is superimposed on the captured image indicated by the captured image data DGa. However, when the line drawing data DGb is used as the editing image data DGd, the editing of the content image can be suitably performed as explained in detail below.

The processing device 32 is a processing device having a function of controlling the units of the information processing device 30 and a function of processing various data. The processing device 32 includes a processor such as a CPU (Central Processing Unit). The processing device 32 may be configured by a single processor or may be configured by a plurality of processors. A part or all of the functions of the processing device 32 may be implemented by hardware such as a DSP (Digital Signal Processor), an ASIC (Application Specific Integrated Circuit), a PLD (Programmable Logic Device), or an FPGA (Field Programmable Gate Array).

The communication device 33 is a communication device capable of communicating with the projector 20 and the like. For example, the communication device 33 is a wired communication device such as a wired LAN (Local Area Network), a USB (Universal Serial Bus), or a HDMI (High Definition Multimedia Interface) or a wireless communication device such as a LPWA (Low Power Wide Area), a wireless LAN including Wi-Fi, or Bluetooth. Each of “HDMI”, “Wi-Fi”, and “Bluetooth” is a registered trademark. The communication device 33 may be capable of communicating with the camera 10 or may be capable of communicating with a device such as an external server.

The display device 34 displays various images under the control by the processing device 32. The display device 34 is a display device including various display panels such as a liquid crystal display panel and an organic EL (electro-luminescence) display panel.

The input device 35 is input equipment that receives operation from the user. For example, the input device 35 includes a pointing device such as a touch pad, a touch panel, or a mouse. When the input device 35 includes the touch panel, the input device 35 may also serve as the display device 34.

In the information processing device 30 explained above, the processing device 32 implements various functions by referring to the various data explained above stored in the storage device 31 and executing the program PR stored in the storage device 31. Specifically, the processing device 32 executes the program PR to thereby function as an acquirer 32a, a display controller 32b, an image editor 32c, a projector controller 32d, and a measurer 32e. The processing device 32 includes the acquirer 32a, the display controller 32b, the image editor 32c, the projector controller 32d, and the measurer 32e.

The acquirer 32a acquires various information from various kinds of equipment coupled to the information processing device 30 by controlling the operation of the communication device 33 and causes the storage device 31 to store the acquired information. For example, the acquirer 32a acquires the captured image data DGa from the camera 10 and acquires the content image data DGc from a not-illustrated server or the like.

The display controller 32b controls the operation of the display device 34 to thereby cause the display device 34 to display various information. Specifically, the display controller 32b causes the display device 34 to display the user interface image GU necessary for executing the content editing method explained below. Here, the display controller 32b causes the display device 34 to display the line drawing indicated by the line drawing data DGb and causes the display device 34 to display an editing image indicated by the editing image data DGd.

The image editor 32c executes various kinds of processing necessary for executing the content editing method explained in detail below. Specifically, the image editor 32c generates the line drawing data DGb based on the captured image data DGa, generates the editing image data DGd based on the line drawing data DGb and the content image data DGc, and edits a content image indicated by the editing image data DGd based on an input result from the user. Here, the line drawing data DGb is generated, for example, by processing the captured image indicated by the captured image data DGa using a publicly-known line drawing generation technique. Therefore, the object OJa, the object OJb, and the object OJc only have to be objects, boundaries of which are detectable from an initially captured image Ga. That is, the object OJa, the object OJb, and the object OJc are not limited to objects independent of one another and at least a part thereof may be continuous or may be flat. The editing image data DGd is generated, for example, by combining the line drawing data DGb or the initial image data DGa0 and the content image data DGc. The content image Gc indicated by the editing image data DGd is edited, for example, by editing the content image data DGc based on an input result from the user and thereafter combining the line drawing data DGb or the initial image data DGa0 and the content image data DGc.

The image editor 32c generates, based on the edited content image data DGc, the projection image data DGe by transformation using the transformation data DGf. The generation of the projection image data DGe may be performed by the projector controller 32d.

The measurer 32e generates the transformation data DGf by measuring a projection surface of the projector 20 using the camera 10 and the projector 20. Specifically, the measurer 32e acquires a plurality of captured images by causing the projector 20 to sequentially project a plurality of pattern images onto the projection target object and causing the camera 10 to capture the projected pattern images. Accordingly, the captured image data DGa is obtained. Based on the plurality of captured images, the measurer 32e associates coordinates of the pattern images in coordinate systems of the captured images of the camera 10 and coordinates of the pattern images in a coordinate system of the display panel of the projector 20 to thereby generate a transformation matrix for performing projective transformation of the coordinate systems. Accordingly, the transformation data DGf is obtained.

The projector controller 32d causes the projector 20 to display various information by controlling the operation of the projector 20. Specifically, the projector controller 32d causes the projector 20 to project the image indicated by the projection image data DGe.

### 1-3. Content Editing Method

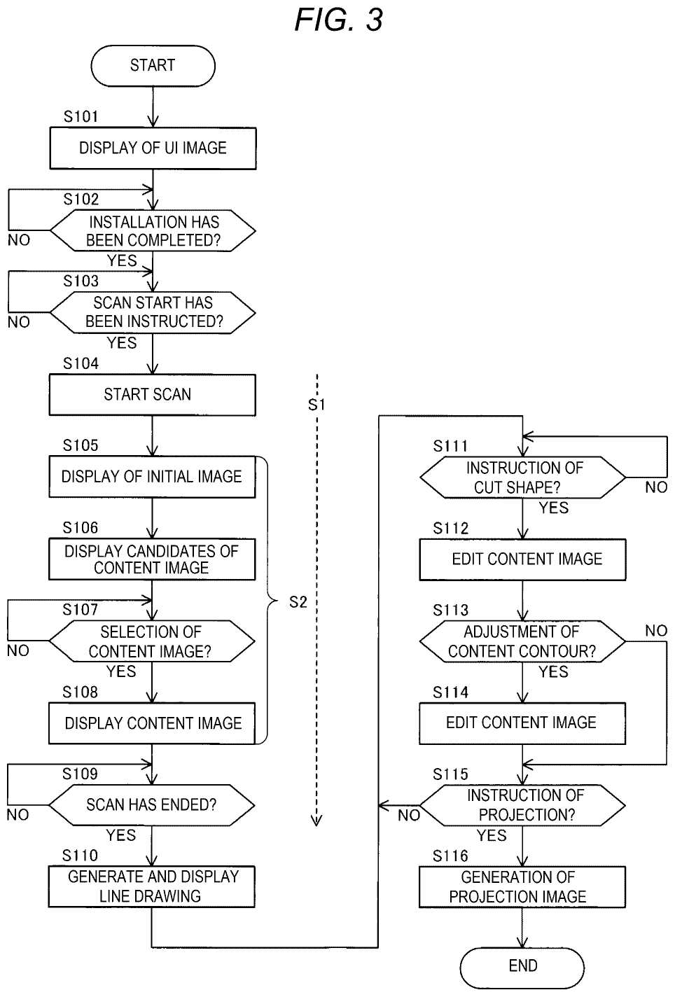

FIG. 3 is a flowchart illustrating a flow of a content editing method according to the first embodiment. The content editing method is executed by the information processing device 30 explained above.

Specifically, as illustrated in FIG. 3, first, in step S101, when the program PR is started, the display controller 32b causes the display device 34 to display the user interface image GU.

Subsequently, in step S102, the measurer 32e determines whether installation of the projector 20 has been completed. This determination is executed based on operation on the user r interface image GU until it is determined that the installation of the projector 20 has been completed (step S102: NO).

When determining that the installation of the projector 20 has been completed (step S102: YES), in step S103, the measurer 32e determines whether an instruction to start scan for measuring the projection surface of the projector 20 has been given. This determination is executed based on operation on the user interface image GU until an instruction to start scan is given (step S103: NO).

When an instruction to start scan has been given (step S103: YES), the measurer 32e starts scan in step S104.

Subsequently, in step S105, the display controller 32b causes the display device 34 to display an initial image, which is an image indicated by the initial image data DGa0.

Subsequently, in step S106, the display controller 32b causes the display device 34 to display a plurality of images as candidates of a content image based on the content image data DGC.

Subsequently, in step S107, the display controller 32b determines whether a content image has been selected. This determination is executed based on operation on the user interface image GU until a content image is selected (step S107: NO).

When a content image has been selected (step S107: YES), in step S108, the display controller 32b causes the display device 34 to display the selected image as a content image. At this time, the image editor 32c generates the editing image data DGd based on data indicating the selected content image and the initial image data DGa0. Then, the display controller 32b causes the display device 34 to display the image indicated by the editing image data DGd. Accordingly, the selected content image is displayed on the display device 34 superimposed on the image indicated by the initial image data DGa0.

Subsequently, in step S109, the display controller 32b determines whether the scan has ended. This determination is executed until the scan ends (step S109: NO). As explained above, the scan is performed as the first processing S1 in a period of step S104 to step S109 explained above. During the execution of the first processing S1, the second processing S2 including step S105 to step S108 explained above is executed.

As explained above, the program PR causes the computer to execute executing the first processing S1 and executing the second processing S2. Here, the first processing S1 acquires, based on a plurality of captured images obtained by capturing a plurality of pattern images sequentially projected from the projector 20 onto the projection region RP, the transformation data DGf used for adjustment of a projection image projected onto the projection region RP. In a period in which the first processing S1 is executed, the second processing S2 that is processing different from the first processing S1 and concerning the projection image is executed.

When the scan has ended (step S109: YES), in step S110, after the image editor 32c generates the line drawing data DGb based on the captured image data DGa, the display controller 32b causes the display device 34 to display the image indicated by the line drawing data DGb. At this time, the image editor 32c generates the editing image data DGd based on the data indicating the selected content image and the line drawing data DGb and updates the editing image data DGd. Then, the display controller 34b causes the display device 34 to display the image indicated by the updated editing image data DGd. Accordingly, the selected content image is displayed on the display device 34 superimposed on the image indicated by the line drawing data DGb.

Subsequently, in step S111, the image editor 32c determines whether a cut shape for the content image has been instructed. This determination is executed until a cut shape for the content image is instructed (step S111: NO).

When a cut shape for the content image has been instructed (step S111: YES), in step S112, the image editor 32c edits, according to at least one of a position, a shape, and a size based on the instruction, the content image displayed on the display device 34.

Subsequently, in step S113, the image editor 32c determines whether a contour shape of the content image has been adjusted. This adjustment is performed using the user interface image GU.

When the contour shape of the content image has been adjusted (step S113: YES), in step S114, the image editor 32c edits, according to the adjustment, the contour shape of the content image displayed on the display device 34.

Thereafter or when the contour shape of the content image has not been adjusted (step S113: NO), in step S115, the image editor 32c determines whether projection by the projector 20 has been instructed. When projection by the projector 20 has not been instructed (step S113: NO), the image editor 32c returns to step S111 explained above.

When projection by the projector 20 has been instructed (step S115: YES), in step S116, the image editor 32c generates the projection image data DGe based on information concerning the position, the shape, and the size of the edited content image. Here, the projection image data DGe is generated, based on the edited content image data DGc, by transformation using the transformation data DGf.

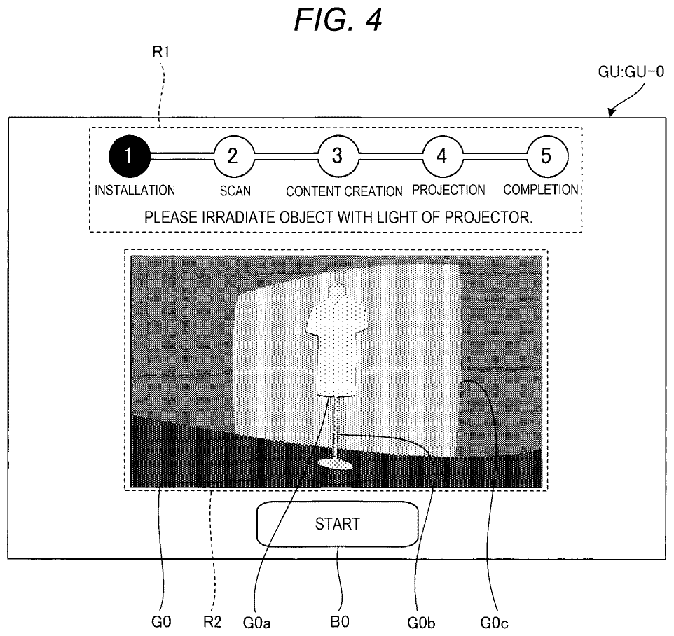

The above is the flow of the content editing method. An example of the user interface image GU used for the content editing method is explained below with reference to FIGS. 4 to 13. In FIGS. 4 to 13, user interface images GU-0 to GU-9 are illustrated as the user interface image GU that transitions according to a progress status of content editing. In the following explanation, the user interface images GU-0 to GU-9 are sometimes referred to as user interface images GU without being distinguished from one another. The user interface image GU is not limited to the examples illustrated in FIGS. 4 to 13.

FIG. 4 is a diagram illustrating installation of the projector 20. FIG. 4 illustrates the user interface image GU-0 displayed on the display device 34 at the time of the execution of step S102 explained above. The user interface image GU-0 includes regions R1 and R2 and a button B0.

In the region R1, a progress status of content editing is displayed. In the example illustrated in FIG. 4, items of “installation”, “scan”, “content creation”, “projection”, and “completion” are displayed in the region R1. An execution target or an executed item and an unexecuted item are displayed in a distinguishable manner.

Here, the items of “installation”, “scan”, “content creation”, “projection”, and “completion” are executed in this order. The item of “installation” is an indication indicating that guidance concerning installation of the camera 10 and the projector 20 is performed. The item of “scan” is an indication indicating that shape measurement for a projection target object is performed. The item “content creation” is an indication indicating that the content image is edited. The item of “projection” is an indication indicating that projection by the projector 20 is performed. The item of “completion” is an indication indicating that the content editing has been completed.

The region R1 of the user interface image GU-0 indicates that “installation” is an execution target. In the region R1, characters “Please irradiate a target object with light of the projector” indicating an installation method of the projector 20 are displayed. At this time, the camera 10 is capable of capturing an image of a projection target object.

In the region R2, a necessary image is displayed according to the progress status of the content editing. In the region R2 of the user interface image GU-0, a captured image G0 by the camera 10 is displayed. The captured image G0 includes an image G0a indicating the object OJa, an image G0b indicating the object OJb, and an image G0c indicating the object OJc. Accordingly, the presence of the projection target object in each of the image capturing region RC of the camera 10 and the projection region RP of the projector 20 can be visually recognized in the region R2.

The button B0 is an indication for receiving advance of an execution target item to the next item when the installation of the projector 20 is completed and is used for the determination of step S102 explained above. When operation on the button B0 is performed, the measurer 32e determines that the installation has been completed (step S102: YES). Then, the execution target item changes to “scan” and step S103 explained above is executed.

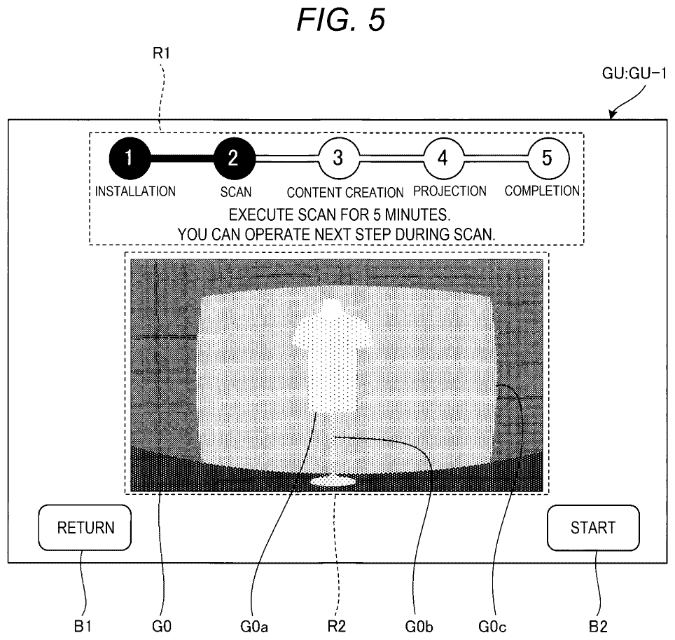

FIG. 5 is a diagram illustrating an instruction to start execution of the first processing S1. FIG. 5 illustrates the user interface image GU-1 displayed on the display device 34 at the time of the execution of step S103 explained above. The user interface image GU-1 includes regions R1 and R2 and buttons B1 and B2.

The region R1 of the user interface image GU-1 indicates that “scan” is the execution target. In the region R1, characters “Execute scan for 5 minutes” indicating that the start of “scan” is prompted are displayed. In the region R1, characters “You can operate the next step during scan” indicating that the second processing S2 can be executed during the execution of the first processing S1 are displayed. Accordingly, the user can learn that processing different from “scan” can be executed during the execution of “scan”.

In the region R2 of the user interface image GU-1, the captured image G0 of the camera 10 is displayed.

The button B1 is an indication for receiving return of the item of the execution target to the preceding item. When operation on the button B1 is performed, the execution target item changes to “installation”.

The button B2 is an indication for receiving the start of processing of the execution target item. When operation on the button B2 is performed, the measurer 32e determines that the start of scan has been instructed (step S103: YES). Then, “scan” to be executed is started. When “scan” is started, the execution target item shifts to “content creation”.

When the execution of “scan” is started, the measurer 32e controls the operation of the projector 20 to sequentially project a plurality of pattern images onto a projection target object and controls the operation of the camera 10 to capture pattern images projected onto the projection target object. Accordingly, a plurality of captured images obtained by capturing the pattern images with the camera 10 are obtained. The measurer 32e measures a projection surface, which is the surface of the projection target object, based on the plurality of captured images. The measurement of the projection surface refers to generation of a transformation matrix for performing projective transformation between a coordinate system of a captured image of the camera 10 and a coordinate system of the display device of the projector 20. The measurer 32e generates, based on the plurality of captured images, the transformation matrix by associating coordinates of the pattern images in the coordinate system of the captured image of the camera 10 and coordinates of the pattern images in the coordinate system of the display device of the projector 20.

As the pattern images, for example, a binary code pattern is used. The binary code pattern refers to an image for expressing a coordinate of the display device using a binary code. The binary code is a technique of expressing, with on and off of a switch, values of digits in the case in which any numerical value is expressed in binary. When a binary code pattern is used as a pattern image, an image projected by the projector 20 corresponds to the switch. Pattern images equivalent to a number of digits of a binary number representing a coordinate value are required. Separate pattern images are required respectively for a coordinate in the longitudinal direction and a coordinate in the lateral direction. For example, when the resolution of the display panel of the projector 20 is 120×90, since each of 120 and 90 is expressed by a binary number of seven digits, seven images are required to express the coordinate in the longitudinal direction and seven images are required to express the coordinate in the lateral direction. Here, the plurality of pattern images include one or both of a white image displaying white over the entire projection region RP and a black image displaying black over the entire projection region RP.

When the binary code pattern is used as the pattern image, in general, the robustness of measurement is reduced by the influence of ambient light such as illumination. For this reason, when the binary code pattern is used as the pattern image, it is preferable to concurrently use a complementary pattern from the viewpoint of suppressing the influence of ambient light and improving the robustness of measurement. The complementary pattern is an image in which black and white are inverted.

The pattern image is not limited to the binary code pattern and may be other structured light such as a dot pattern, a rectangular pattern, a polygonal pattern, a checker pattern, a gray code pattern, a phase shift pattern, or a random dot pattern.

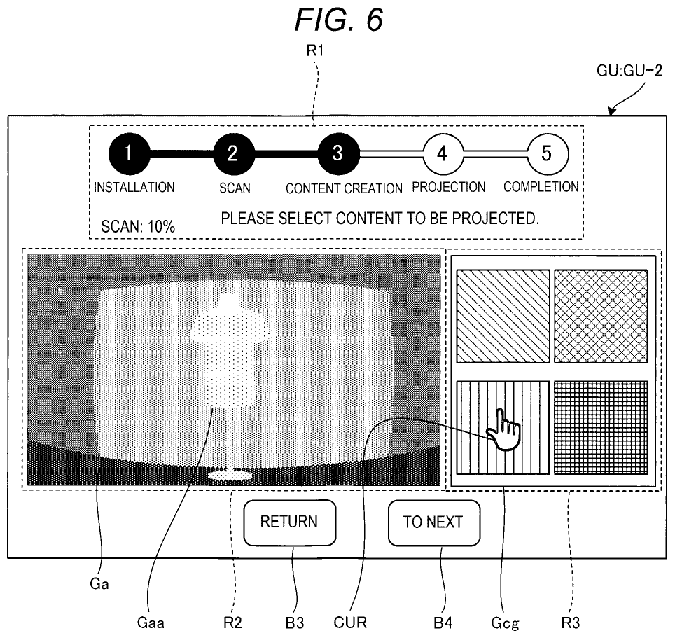

FIG. 6 is a diagram illustrating selection of a content image. FIG. 6 illustrates the user interface image GU-2 displayed on the display device 34 at the time of the execution of step S107 explained above. The user interface image GU-2 includes buttons B3 and B4 instead of the buttons B1 and B2 of the user interface image GU-1 and includes a region R3.

In the region R3, an image Gcg including a plurality of content images indicated by the content image data DGc is displayed as a candidate. Each of the plurality of content images is capable of receiving selection. According to the presence or absence of the selection, the determination in step S107 explained above is performed. When this selection is performed, the display controller 32b determines that a content image has been selected (step S107: YES). Then, step S108 explained above is executed. The number of content images displayed in the region R3 is not limited to the example illustrated in FIG. 6 and is optional and may be three or less or five or more or may be one.

As explained above, when the input from the user is received in step S107 in the period of executing the first processing S1, the program PR executes step S108 of the second processing S2. The second processing S2 includes, in step S107, selecting the content image Gc to be used as at least a part of the projection image.

In step S106, the program PR in the present embodiment executes displaying a plurality of candidates of the content image Gc. The second processing S2 includes, in step S107, selecting one of the plurality of candidates as the content image Gc.

The region R1 of the user interface image GU-2 indicates that “content creation” is the execution target. In the region R1, characters “Please select content to be projected” indicating that selection of a content image is prompted are displayed. In the region R1 of the user interface image GU-2, a progress status of scan is illustrated. FIG. 6 exemplifies a case in which the progress status of the scan is 10%.

The initially captured image Ga indicated by the initial image data DGa0 is displayed in the region R2 of the user interface image GU-2. The initially captured image Ga includes an image Gaa indicating the object OJa. The initial image data DGa0 is generated during scan. After the initial image data DGa0 is generated, the initially captured image Ga indicated by the initial image data DGa0 is displayed in step S105.

As explained above, the second processing S2 includes, in step S105, processing using the initial image data DGa0, which is an example of information obtained during the execution of the first processing S1. Here, the plurality of captured images indicated by the captured image data DGa include the initially captured image Ga, which is a captured image obtained by capturing an image of the projection region RP in the initial state. The second processing S2 includes, in step S105, processing using the initially captured image Ga.

The button B3 is an indication for receiving return of the execution target item to “scan”, which is an item before “content creation”. The button B4 is an indication for receiving the completion of selection of a content image. When operation on the button B4 is performed, step S111 explained above is executed. However, the operation on the button B4 is allowed after the execution of step S110 and cannot be received otherwise.

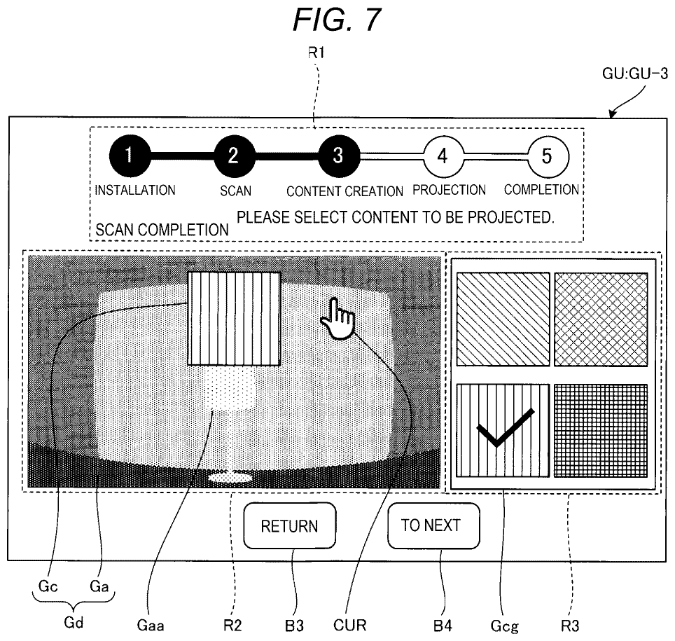

FIG. 7 is a diagram illustrating a display example of the content image Gc superimposed on the initially captured image Ga. FIG. 7 illustrates the user interface image GU-3 displayed on the display device 34 by the execution of step S108 explained above. The user interface image GU-3 is displayed when one content image is selected in the user interface image GU-2.

FIG. 7 illustrates a state in which a lower left content image among four content images displayed in the region R3 is selected. FIG. 7 exemplifies a case in which characters indicating that scan has been completed are displayed in the region R1. When the scan is completed, step S110 is executed and operation on the button B4 can be received.

In the region R2 of the user interface image GU-3, the editing image Gd indicated by the editing image data DGd is displayed. Here, the editing image Gd is an image in which the initially captured image Ga indicated by the initial image data DGa0 and the content image Gc indicated by the content image data DGc are superimposed. In the example illustrated in FIG. 7, the content image Gc indicated by the content image data DGc is superimposed on a part of the initially captured image Ga. The content image Gc only has to be superimposed on at least a part of the initially captured image Ga or may be superimposed on the entire initially captured image Ga.

As explained above, the second processing S2 includes, in step S108, processing of displaying the content image Gc superimposed on the initially captured image Ga.

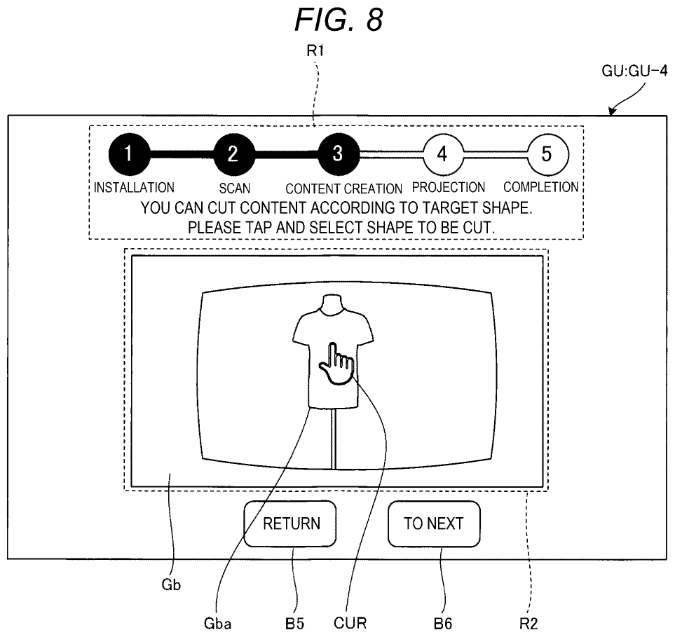

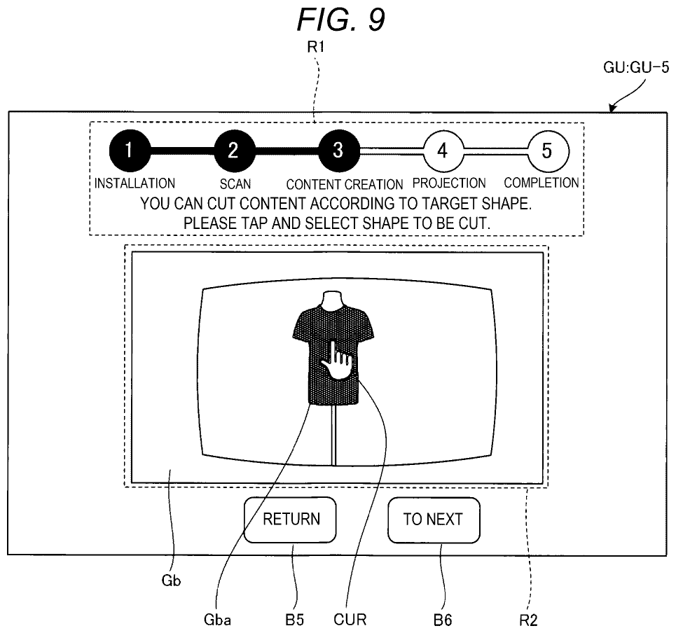

FIGS. 8 and 9 are diagrams illustrating display examples after the first processing S1. FIG. 8 illustrates the user interface image GU-4 displayed on the display device 34 when step S111 explained above is executed. In FIG. 9, the user interface image GU-5 displayed on the display device 34 at the time of the execution of step S111 explained above is illustrated. The user interface images GU-4 and GU-5 include buttons B5 and B6 instead of the buttons B3 and B4 of the user interface image GU-3. In the user interface images GU-4 and GU-5, the display of the region R3 is omitted.

The region R1 of the user interface image GU-4 indicates that “content creation” is the execution target. In the region R1, characters such as “Please tap and select a shape to be cut” indicating that designation of a cut shape of a content image is prompted after the selection of the content image are displayed.

The line drawing Gb indicated by the line drawing data DGb is displayed in the region R2 of the user interface image GU-4. The line drawing Gb includes an image Gba indicating the object OJa. Accordingly, the visibility of the contour of the projection target object can be improved. Here, the image Gba is represented as a closed region segmented by the line of the line drawing Gb.

As explained above, after the execution of the first processing S1 ends, in step S110, the program PR causes the computer to execute displaying, instead of the initially captured image Ga, the image Gba in which the contour of the object OJa included in the projection region RP is indicated by a line.

Here, the line drawing Gb can receive selection of a closed region segmented by the line of the line drawing Gb. When this selection is performed, the shape of the selected closed region is designated as a cut shape and step S112 explained above is executed. In the examples illustrated in FIGS. 8 and 9, a desired closed region is selected by being tapped by the cursor CUR. FIG. 8 illustrates a state before the closed region corresponding to the image Gba indicating the object OJa is selected. FIG. 9 illustrates a state in which the closed region corresponding to the image Gba indicating the object OJa is selected.

Here, the selected closed region is highlighted. In the example illustrated in FIG. 9, the selected closed region is displayed in a color different from a color of the other regions. A method of highlighting is not limited to the example illustrated in FIG. 9 and may be, for example, a method of thickening a line indicating the contour of the selected closed region.

The button B5 is an indication for receiving return of the content image to a selectable state. The button B6 is an indication for receiving completion of designation of a cut shape. When operation on the button B6 is performed, the image editor 32c determines that a cut shape for the content image has been instructed (step S111: YES). Then, step S112 explained above is executed.

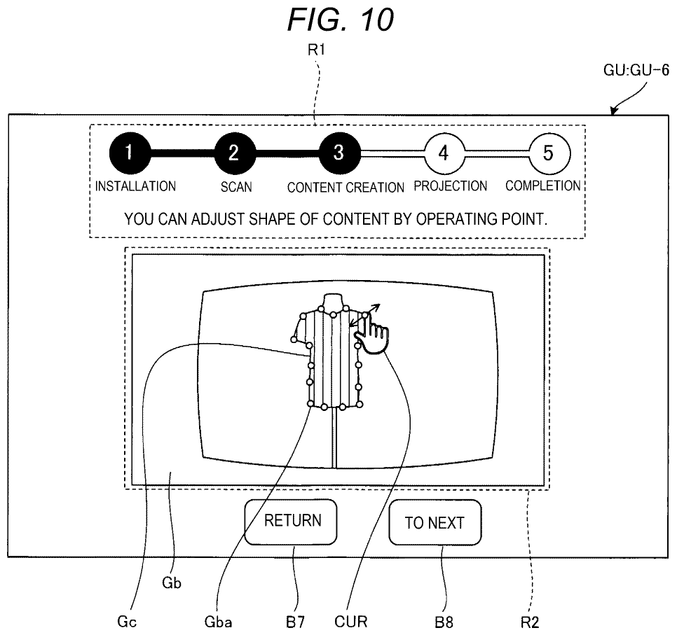

FIG. 10 is a diagram illustrating editing of a content image after the first processing S1. FIG. 10 illustrates the user interface image GU-6 displayed on the display device 34 at the time of the execution of step S113 explained above. The user interface image GU-6 is the same as the user interface images GU-4 and GU-5 explained above except that the user interface image GU-6 includes buttons B7 and B8 instead of the buttons B5 and B6.

The region R1 of the user interface image GU-6 indicates that “content creation” is the execution target. In the region R1, characters such as “You can adjust the shape of content” indicating that the shape of the content image can be adjusted.

In the region R2 of the user interface image GU-6, the content image Gc having a shape trimmed to match the shape of the image Gba is displayed superimposed on the line drawing Gb. The content image Gc having the trimmed shape may be displayed by editing the content image data DGc to cut an unnecessary portion of the content image Gc or may be displayed by, without editing the content image data DGc, displaying a mask image that hides the unnecessary portion of the content image Gc.

Here, the content image Gc is capable of receiving adjustment of a contour shape. In the example illustrated in FIG. 10, a plurality of dots are arranged along the contour of the content image Gc. The contour shape of the content image Gc is adjusted by selecting any one dot from the plurality of dots and thereafter moving the selected dot using the cursor CUR. When the adjustment is performed, the image editor 32c determines that the contour shape of the content image has been adjusted (step S113: YES). Then, step S114 explained above is executed. An indication for adjusting the contour shape of the content image Gc is not limited to the example illustrated in FIG. 10 and is optional.

The button B7 is an indication for receiving return of the cut shape to a state in which the cut shape can be designated. The button B8 is an indication for receiving advance of the execution target item to the next item. When operation on the button B8 is performed, the execution target shifts to “projection”.

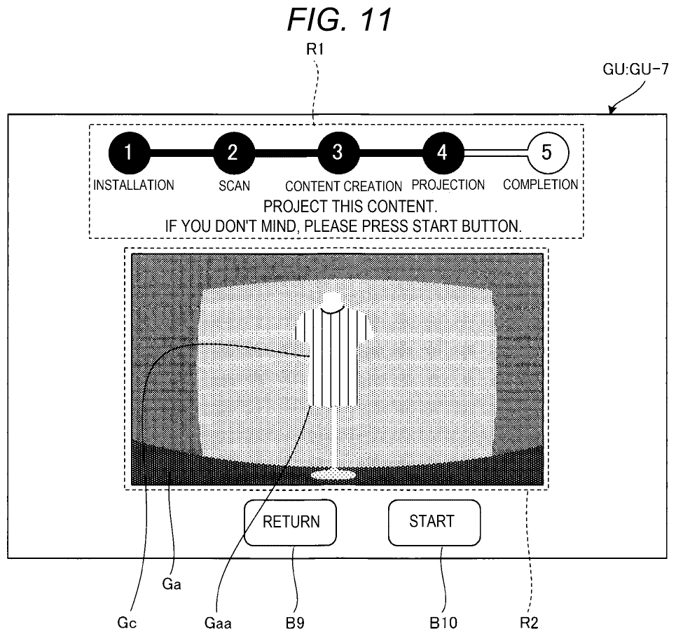

FIG. 11 is a diagram illustrating generation of a projection image. FIG. 11 illustrates the user interface image GU-7 displayed on the display device 34 during the execution of step S115 explained above. The user interface image GU-7 is the same as the user interface image GU-6 explained above except that the user interface image GU-7 includes buttons B9 and B10 instead of the buttons B7 and B8 and the initially captured image Ga is displayed in the region R2 instead of the line drawing Gb.

The region R1 of the user interface image GU-7 indicates that “projection” is the execution target. In the region R1, characters such as “Project this content” indicating that the content image can be projected are displayed.

In the region R2 of the user interface image GU-7, the trimmed content image Gc is displayed superimposed on the initially captured image Ga. As explained above, by displaying the trimmed content image Gc superimposed on the initially captured image Ga, an image close to an actual projection state of the content image Gc can be more visually provided by the display of the display device 34. The captured image displayed in the user interface image GU-7 may not be the initially captured image Ga. The captured image may be, for example, an image captured anew after the completion of “scan”.

The button B9 is an indication for receiving return of the execution target item to the preceding item. When operation on the button B9 is performed, the execution target item changes to “content creation”.

The button B10 is an indication for receiving the start of processing of generating the projection image data DGe. When operation on the button B10 is performed, the image editor 32c determines that projection by the projector 20 has been instructed (step S115: YES). Then, by the execution of step S116 explained above, projection image data DGe is generated based on the edited content image Gc using the transformation data DGf.

As explained above, in step S116, the program PR causes the computer to execute editing the content image Gc using the transformation data DGf to thereby generate a projection image.

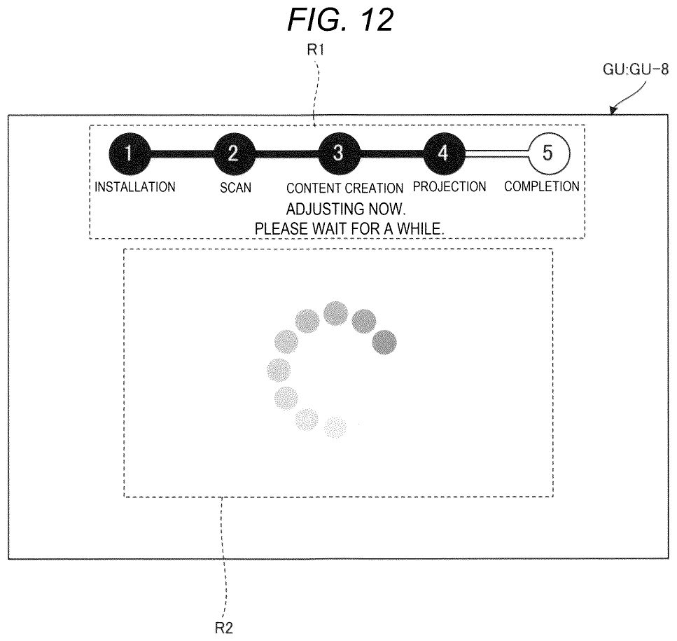

FIG. 12 is a diagram illustrating a display example during the generation of the projection image. FIG. 12 illustrates the user interface image GU-8 displayed on the display device 34 during the execution of step S116 explained above. The user interface image GU-8 is the same as the user interface image GU-7 explained above except that the buttons B9 and B10 are omitted.

The region R1 of the user interface image GU-8 indicates that “projection” is the execution target. In the region R1, characters “Adjusting now. Please wait for a while.” indicating that the generation processing of the projection image data DGe is in progress are displayed.

In the region R2 of the user interface image GU-8, an image indicating that processing is in progress is displayed. The image is not limited to the example illustrated in FIG. 12 and is optional.

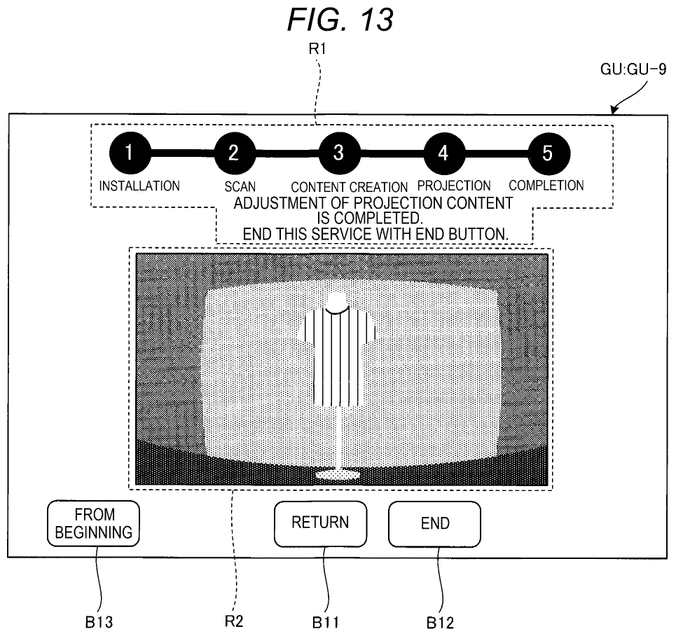

FIG. 13 is a diagram illustrating a display example of completion of generation of a projection image. FIG. 13 illustrates the user interface image GU-9 displayed on the display device 34 after the execution of step S116 explained above. The user interface image GU-9 is the same as the user interface image GU-7 explained above except that the user interface image GU-9 includes buttons B11, B12, and B13 instead of the buttons B9 and B10.

The region R1 of the user interface image GU-9 indicates that “completion” is the execution target. In the region R1, characters such as “Adjustment of projection content is completed” indicating that content editing has been completed are displayed.

The button B11 is an indication for receiving return of the execution target item to the preceding item. When operation on the button B11 is performed, the execution target item changes to “content creation”.

The button B12 is an indication for receiving the end of content editing by the user interface image GU. When operation on the button B12 is performed, the display of the user interface image GU is ended. The projection image data DGe indicating the generated projection image is stored in the storage device 31.

The button B13 is an indication for receiving return of the execution target item to “installation”. When operation on the button B13 is performed, the execution target item changes to “installation”.

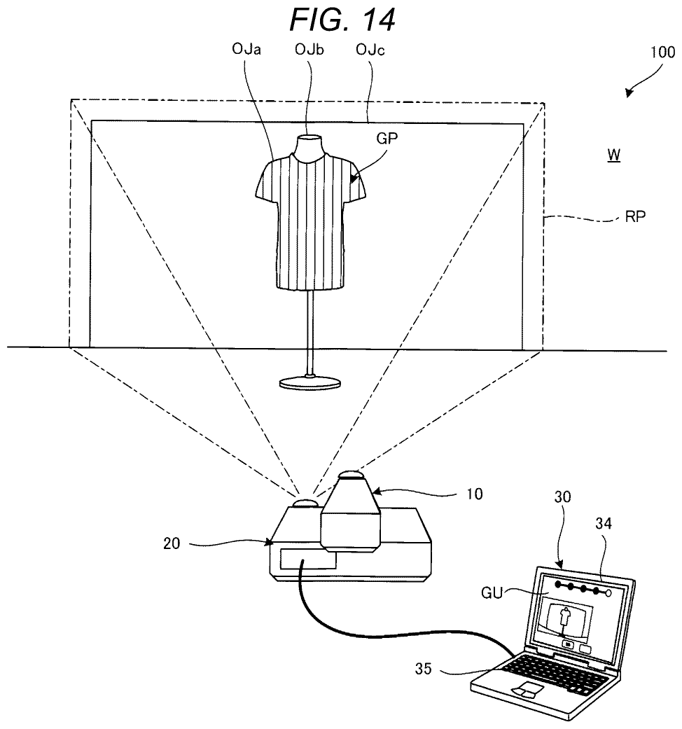

FIG. 14 is a diagram illustrating projection using the edited content image Gc. The information processing device 30 reads the projection image data DGe from the storage device 31 and outputs the projection image data DGe to the projector 20 via the communication device 33. Accordingly, as illustrated in FIG. 14, the edited content image Gc explained above is projected onto the object OJa by the projector 20.

As explained above, the content editing method includes executing the first processing S1 of acquiring, based on a plurality of captured images respectively obtained by capturing a plurality of pattern images sequentially projected from the projector 20 onto the projection region RP, the transformation data DGf used for adjustment of a projection image projected onto the projection region RP and, in a period in which the first processing S1 is executed, executing the second processing S2 that is processing different from the first processing S1 and concerning the projection image.

As explained above, the information processing device 30 includes the processing device 32 that executes the content editing method explained above. The processing device 32 executes the first processing S1 of acquiring, based on a plurality of captured images respectively obtained by capturing a plurality of pattern images sequentially projected onto the projection region RP from the projector 20, the transformation data DGf used for adjustment of a projection image projected onto the projection region RP. In a period in which the first processing S1 is executed, the processing device 32 executes the second processing S2 that is different from the first processing S1 and concerning the projection image.

In the content editing method, in the information processing device 30 or the program PR, the second processing S2 that is the processing different from the first processing S1 and concerning the projection image is executed in the period in which the first processing S1 is executed. Therefore, compared with an aspect in which the second processing S2 is performed after the execution of the first processing S1 is completed, it is possible to reduce a time required from the start of the first processing S1 to the completion of the second processing S2. That is, it is possible to reduce the time required from the start of the first processing S1 to the completion of the second processing S2 by effectively using, for the execution of the second processing S2 different from the first processing S1, a period in which the first processing S1 is executed.

As explained above, the program PR in the present embodiment causes the computer to execute the second processing S2 when input from the user is received in the period in which the first processing S1 is executed. For this reason, it is possible to effectively use the execution period of the first processing S1 for the execution of the second processing S2 according to the user's intention.

As explained above, the second processing S2 includes selecting the content image Gc to be used for at least a part of the projection image. For this reason, it is possible to effectively use the execution period of the first processing S1 to select the content image Gc. Here, the selection of the content image Gc can be executed in the execution period of the first processing S1 because a final processing result of the first processing S1 is not used.

Further, as explained above, the program PR further causes the computer to execute displaying a plurality of candidates of the content image Gc. The second processing S2 includes selecting one of the plurality of candidates as the content image Gc. Therefore, it is possible to effectively use the execution period of the first processing S1 to display a plurality of candidates of the content image. Here, the display of the plurality of candidates can be executed in the execution period of the first processing S1 because the final processing result of the first processing S1 is not used.

As explained above, the second processing S2 includes the processing using the information obtained halfway in the execution of the first processing S1. Therefore, it is possible to effectively use the execution period of the first processing S1 for the processing using the information obtained halfway in the execution of the first processing S1. Here, the processing using the information obtained halfway in the execution of the first processing S1 can be executed in the execution period of the first processing S1 because the final processing result of the first processing S1 is not used.

Further, as explained above, the plurality of captured images indicated by the captured image data DGa include the initially captured image Ga, which is the captured image obtained by capturing an image of the projection region RP in the initial state. The second processing S2 includes processing using the initially captured image Ga. For this reason, it is possible to effectively use the execution period of the first processing S1 for the processing using the initially captured image Ga. Here, the processing using the initially captured image Ga can be executed in the execution period of the first processing S1 because the final processing result of the first processing S1 is not used.

As explained above, the second processing S2 includes the processing of displaying the content image Gc superimposed on the initially captured image Ga. For this reason, it is possible to effectively use the execution period of the first processing S1 for the processing of displaying the content image Gc superimposed on the initially captured image Ga. Here, the processing of displaying the content image Gc superimposed on the initially captured image Ga can be executed in the execution period of the first processing S1 because the final processing result of the first processing S1 is not used.

Further, as explained above, the projection region RP includes the object OJa. After the execution of the first processing S1 ends, the program PR further causes the computer to execute displaying, instead of the initially captured image Ga, the image Gba in which the contour of the object OJa is indicated by a line. For this reason, it is possible to accurately display, using the final processing result of the first processing S1, the image Gba in which the contour of the object is indicated by a line.

As explained above, the program PR further causes the computer to execute generating a projection image by editing the content image Gc using the transformation data DGf. For this reason, after the completion of the first processing S1, it is possible to generate an accurate projection image by editing the content image Gc using the transformation data DGf.

### 2. Second Embodiment

A second embodiment of the present disclosure is explained below. In the embodiment exemplified below, the reference numerals and signs used in the explanation in the first embodiment are used for elements having the same action and functions as those in the first embodiment, and detailed explanation of the elements is omitted as appropriate.

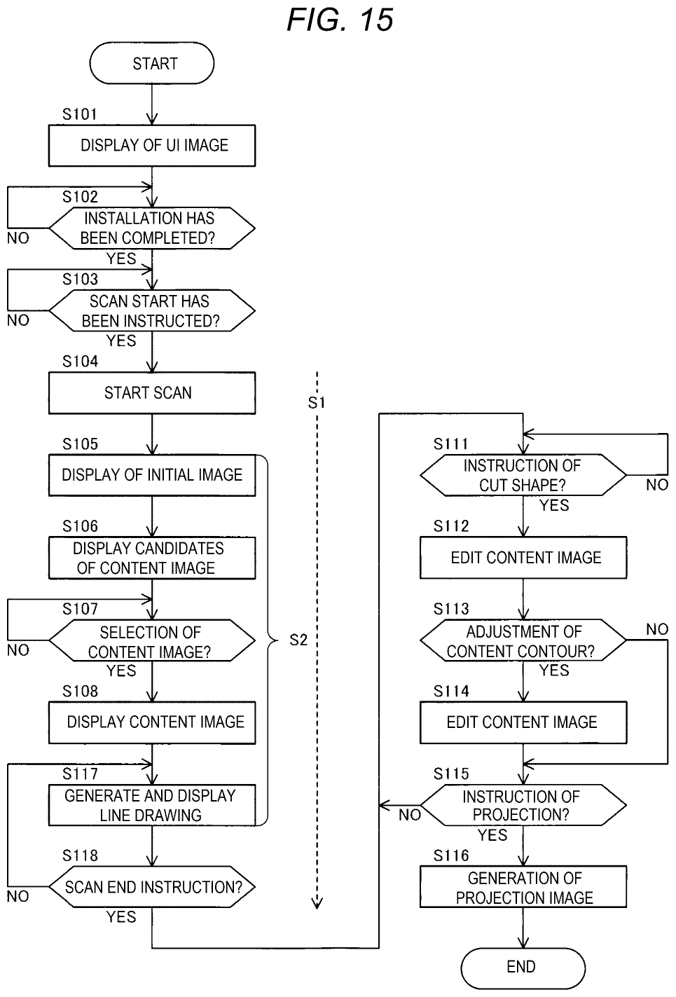

FIG. 15 is a flowchart illustrating a flow of a content editing method according to the second embodiment. The present embodiment is the same as the first embodiment explained above except that steps S117 and S118 are executed instead of steps S109 and S110.

In the present embodiment, as illustrated in FIG. 15, after the execution of step S108, in step S117, after the image editor 32c generates the line drawing data DGb based on the captured image data DGa, the display controller 32b causes the display device 34 to display the image indicated by the line drawing data DGb. In step S117, the scan is not completed. Although the captured images have been acquired for the plurality of pattern images, capturing of all the pattern images is not completed. Accordingly, in step S117, a transformation matrix is generated from the acquired captured images. Compared with when all the pattern images are used, the accuracy of the transformation matrix is low.

Subsequently, in step S118, the display controller 32b determines whether the end of the scan has been instructed. This determination is performed based on operation on the user interface image GU.

When the end of the scan has not been instructed (step S118: NO), the scan is continued and step S117 explained above is executed. On the other hand, when the end of the scan has been instructed (step S118: YES), the scan is stopped and step S111 is executed. In the processing of step S111 and subsequent steps, a transformation matrix generated based on captured images captured up to the time when the end of the scan is instructed is used. If the end of the scan is not instructed before the completion of the scan, the processing shifts to step S111 when the scan is completed.

As explained above, in the present embodiment, the scan is executed as the first processing S1 in the period from step S104 to step S118 explained above. During the execution of the first processing S1, the second processing S2 including step S105 to step S117 explained above is executed.

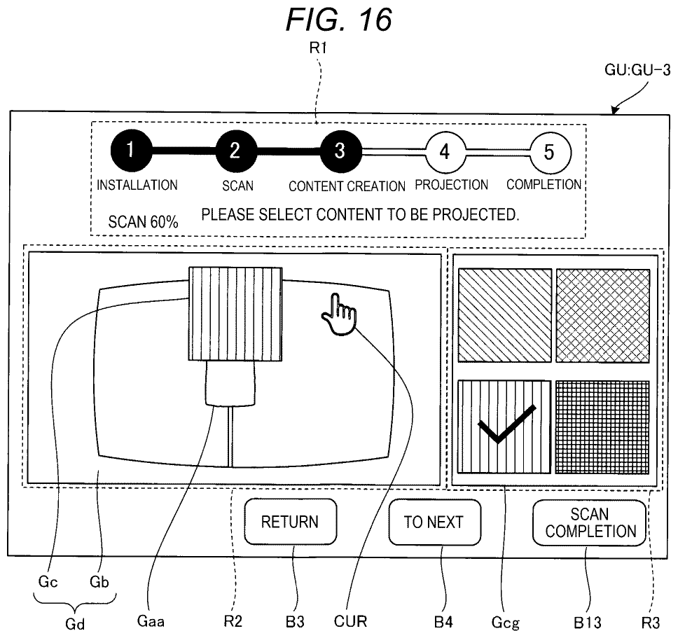

FIG. 16 is a diagram illustrating a display example of the content image Gc superimposed on the line drawing Gb. FIG. 16 illustrates the user interface image GU-3 displayed on the display device 34 by the execution of step S117 explained above. The user interface image GU-3 in the present embodiment is the same as the user interface image GU-3 in the first embodiment except that the line drawing Gb indicated by the line drawing data DGb is displayed in the region R2 instead of the initially captured image Ga.

That is, in the region R2 of the user interface image GU-3 in the present embodiment, the editing image Gd in which the line drawing Gb indicated by the line drawing data DGb and the content image Gc indicated by the content image data DGc are superimposed is displayed. In the example illustrated in FIG. 16, the content image Gc indicated by the content image data DGc is superimposed on a part of the line drawing Gb.

According to the second embodiment explained above as well, it is possible to reduce a processing time required for editing content. In the present embodiment, as explained above, the second processing S2 includes displaying, instead of the initially captured image Ga, the image Gba in which the contour of the object OJa included in the projection region RP is indicated by a line and receiving input for stopping the execution of the first processing S1. Therefore, during the execution period of the first processing S1, it is possible to display, using information obtained halfway in the execution of the first processing S1, the image Gba in which the contour of the object OJa is indicated by a line with display accuracy corresponding to a progress status of the first processing S1. It is possible to stop the first processing SI at a stage when display accuracy necessary for the user can be obtained. For this reason, it is possible to reduce, according to the user's desire, a time required from the start of the first processing SI to the completion of the second processing S2.

### 3. Modifications

The embodiments exemplified above can be variously modified. Specific aspects of modifications applicable to the embodiments explained above are exemplified below. Two or more aspects optionally selected from the following exemplification can be combined as appropriate in a range in which the aspects do not contradict one another.

### 3-1. Modification 1

In the embodiments explained above, the aspect in which the cut shape of the content image is designated using the image in which the object OJa is indicated by the line drawing is exemplified. However, this aspect is not limiting and, for example, the image for specifying the cut shape of the content image may be an image in which the contour is indicated by differentiating a color of the contour of the object OJa between the inside and the outside of the contour.

### 3-2. Modification 2

In the embodiments explained above, the aspect in which the number of objects that can be the projection target object is one is exemplified. However, this aspect is not limiting and the number may be two or more.

### 3-3. Modification 3

In the embodiments explained above, for example, the aspect in which, as the second processing, the content image is selected is exemplified. However, this aspect is not limiting. For example, the processing concerning the generation of the projection image may be processing of adding image data to the content image data DGC. Specifically, image data, for example, a photograph or a moving image, stored in the storage device 31 separately from the content image data DGc may be displayed on the display device 34 as a candidate to be added to the content image data DGc and may be added to the content image data DGc according to selection operation by the user. A candidate image to be added may be acquired from an external device accessible by the information processing device 30 via the communication device 33.

### 4. Appendixes

A summary of the present disclosure is appended below.

(Appendix 1) A recording medium recording a program, the program causing a computer to execute: executing first processing of acquiring, based on a plurality of captured images obtained by respectively capturing a plurality of pattern images sequentially projected from a projector onto a projection region, measurement information used for adjustment of a projection image projected onto the projection region; and executing, in a period in which the first processing is executed, second processing that is processing different from the first processing and concerning the projection image.

In the aspect of the appendix 1 explained above, the second processing that is the processing different from the first processing and concerning the projection image is executed in the period in which the first processing is executed. Therefore, it is possible to reduce a time required from the start of the first processing to the completion of the second processing compared with an aspect in which the second processing is performed after the execution of the first processing is completed. That is, it is possible to reduce the time required from the start of the first processing to the completion of the second processing by effectively using, for the execution of the second processing different from the first processing, the period in which the first processing is executed.

(Appendix 2) The recording medium recording the program according to the appendix 1, wherein, when input from a user is received in the period in which the first processing is executed, the second processing is executed. In the aspect of the appendix 2 explained above, it is possible to effectively use the execution period of the first processing for the execution of the second processing according to the user's intention.

(Appendix 3) The recording medium recording the program according to the appendix 1 or the appendix 2, wherein the second processing includes selecting a content image used in at least a part of the projection image. In the aspect of the appendix 3 explained above, it is possible to effectively use the execution period of the first processing to select the content image. Here, the selection of the content image can be executed in the execution period of the first processing because a final processing result of the first processing is not used.

(Appendix 4) The recording medium recording the program according to the appendix 3, the program further causing the computer to execute displaying a plurality of candidates of the content image, wherein the second processing includes selecting one candidate among the plurality of candidates as the content image. In the aspect of the appendix 4 explained above, it is possible to effectively use the execution period of the first processing to display the plurality of candidates of the content image. Here, the display of the plurality of candidates can be executed in the execution period of the first processing because the final processing result of the first processing is not used.

(Appendix 5) The recording medium recording the program according to any one of the appendix 1 to the appendix 4, wherein the second processing includes processing using information obtained halfway in the execution of the first processing. In the aspect of the appendix 5, it is possible to effectively use the execution period of the first processing for the processing using the information obtained halfway in the execution of the first processing. Here, the processing using the information obtained halfway in the execution of the first processing can be executed in the execution period of the first processing because the final processing result of the first processing is not used.

(Appendix 6) The recording medium recording the program according to the appendix 5, wherein the plurality of captured images include an initially captured image, which is a captured image obtained by capturing an image of the projection region in an initial state, and the second processing includes processing using the initially captured image. In the aspect of the appendix 6, it is possible to effectively use the execution period of the first processing for the processing using the initially captured image. Here, the processing using the initially captured image can be executed in the execution period of the first processing because the final processing result of the first processing is not used.

(Appendix 7) The recording medium recording the program according to the appendix 6, wherein the second processing includes processing of displaying a content image superimposed on the initially captured image. In the aspect of the appendix 7 explained above, it is possible to effectively use the execution period of the first processing for the processing of displaying the content image superimposed on the initially captured image. Here, the processing of displaying the content image superimposed on the initially captured image can be executed in the execution period of the first processing because the final processing result of the first processing is not used.

(Appendix 8) The recording medium recording the program according to the appendix 7, wherein the projection region further includes an object, and the program further causes the computer to execute, after completion of the first processing, displaying, instead of the initially captured image, an image in which a contour of the object is indicated by a line. In the aspect of the appendix 8 explained above, it is possible to accurately display, using a final processing result of the first processing, the image in which the contour of the object is indicated by the line.

(Appendix 9) The recording medium recording the program according to the appendix 7, wherein the projection region includes an object, and the second processing further includes: displaying, instead of the initially captured image, an image in which a contour of the object is indicated by a line; and receiving input for stopping the execution of the first processing. In the aspect of the appendix 9 explained above, in the execution period of the first processing, it is possible to display, using the information obtained halfway in the execution of the first processing, the image in which the contour of the object is indicated by the line. It is possible to stop the first processing at a stage when display accuracy necessary for the user can be obtained. For this reason, it is possible to reduce, according to the user's desire, the time required from the start of the first processing to the completion of the second processing.

(Appendix 10) The recording medium recording the program according to any one of the appendix 1 to the appendix 9, the program further causing the computer to execute generating the projection image by editing a content image using the measurement information. In the aspect of the appendix 10 explained above, it is possible to generate an accurate projection image by editing the content image using the measurement information after completion of the first processing.

(Appendix 11) A content editing method comprising: executing first processing of acquiring, based on a plurality of captured images obtained by respectively capturing a plurality of pattern images sequentially projected from a projector onto a projection region, measurement information used for adjustment of a projection image projected onto the projection region; and executing, in a period in which the first processing is executed, second processing that is processing different from the first processing and concerning the projection image.

In the aspect of the appendix 11 explained above, the second processing that is the processing different from the first processing and concerning the projection image is executed in the period in which the first processing is executed. Therefore, it is possible to reduce a time required from the start of the first processing to the completion of the second processing compared with an aspect in which the second processing is performed after the execution of the first processing is completed. That is, it is possible to reduce the time required from the start of the first processing to the completion of the second processing by effectively using, for the execution of the second processing different from the first processing, the period in which the first processing is executed.

(Appendix 12) An information processing device comprising a processing device configured to execute: executing first processing of acquiring, based on a plurality of captured images obtained by respectively capturing a plurality of pattern images sequentially projected from a projector onto a projection region, measurement information used for adjustment of a projection image projected onto the projection region; and executing, in a period in which the first processing is executed, second processing that is processing different from the first processing and concerning the projection image.

In the aspect of the appendix 12 explained above, the second processing that is the processing different from the first processing and concerning the projection image is executed in the period in which the first processing is executed. Therefore, it is possible to reduce a time required from the start of the first processing to the completion of the second processing compared with an aspect in which the second processing is performed after the execution of the first processing is completed. That is, it is possible to reduce the time required from the start of the first processing to the completion of the second processing by effectively using, for the execution of the second processing different from the first processing, the period in which the first processing is executed.

What is claimed is:

1. A recording medium recording a program, the program causing a computer to execute:
executing first processing of acquiring, based on a plurality of captured images obtained by respectively capturing a plurality of pattern images sequentially projected from a projector onto a projection region, measurement information used for adjustment of a projection image projected onto the projection region; and
executing, in a period in which the first processing is executed, second processing that is processing different from the first processing and concerning the projection image.

2. The recording medium recording the program according to claim 1, wherein, when input from a user is received in the period in which the first processing is executed, the second processing is executed.

3. The recording medium recording the program according to claim 1, wherein the second processing includes selecting a content image used in at least a part of the projection image.

4. The recording medium recording the program according to claim 1, the program further causing the computer to execute displaying a plurality of candidates of a content image, wherein
the second processing includes selecting one candidate among the plurality of candidates as the content image.

5. The recording medium recording the program according to claim 1, wherein the second processing includes processing using information obtained halfway in the execution of the first processing.

6. The recording medium recording the program according to claim 5, wherein
the plurality of captured images include an initially captured image, which is a captured image obtained by capturing an image of the projection region in an initial state, and
the second processing includes processing using the initially captured image.

7. The recording medium recording the program according to claim 6, wherein the second processing includes processing of displaying a content image superimposed on the initially captured image.

8. The recording medium recording the program according to claim 7, wherein
the projection region includes an object, and
the program further causes the computer to execute, after completion of the first processing, displaying, instead of the initially captured image, an image in which a contour of the object is indicated by a line.

9. The recording medium recording the program according to claim 7, wherein
the projection region includes an object, and the second processing further includes displaying, instead of the initially captured image, an image in which a contour of the object is indicated by a line; and
receiving input for stopping the execution of the first processing.

10. The recording medium recording the program according to claim 1, the program further causing the computer to execute generating the projection image by editing a content image using the measurement information.

11. A content editing method comprising:
executing first processing of acquiring, based on a plurality of captured images obtained by respectively capturing a plurality of pattern images sequentially projected from a projector onto a projection region, measurement information used for adjustment of a projection image projected onto the projection region; and
executing, in a period in which the first processing is executed, second processing that is processing different from the first processing and concerning the projection image.

12. An information processing device comprising:
a processing device programmed to
execute first processing of acquiring, based on a plurality of captured images obtained by respectively capturing g a plurality of pattern images sequentially projected from a projector onto a projection region, measurement information used for adjustment of a projection image projected onto the projection region; and
execute, in a period in which the first processing is executed, second processing that is processing different from the first processing and concerning the projection image.
